(19) United States
(12) Patent Application Publication
(10) Pub. No.: US 2025/0208206 A1
(43) Pub. Date: Jun. 26, 2025

(54) AUTOMATED LOW POWER CELL INSERTION IN DFT-ENABLED MULTI POWER PLANE DESIGNS

(71) Applicant: Intel Corporation, Santa Clara, CA (US)

(72) Inventor: Jay RAVAL, Hillsboro, OR (US)

(21) Appl. No.: 18/391,728

(22) Filed: Dec. 21, 2023

(51) Int. Cl. G01R 31/317

(52) U.S. Cl. CPC G01R 31/31704

(57) ABSTRACT

A method includes determining a register-transfer level and Unified Power Format (RTL-UPF) description for a circuit that includes a plurality of RTL modules, at least two of the RTL modules being located in different power plane domains; determining a design for test (DFT) for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing; determining an isolation cell requirement for the at least one power domain crossing; selecting an RTL-UPF isolation rule using the determined isolation cell requirement for the at least one power domain crossing; and inserting an isolation cell described by the selected RTL isolation rule into the DFT.

### TECHNICAL FIELD

Various aspects of this disclosure relate generally to a system and a method for Design for Test of a System on Chip.

### BACKGROUND

One of the most fundamental parts of any system-on-chip (SOC) testing is the so-called Design for Test (DFT). Design for Test is an integrated-circuit technique that allows testability after chip fabrication in order to detect manufacturing defects that may impact functionality or electrical parameters of the integrated circuit. DFT usually includes a control logic and dedicated scannable flip flops, which are connected to the control logic. For systems on chip (SOC) with multi power plane designs, a power domain crossing between DFT control logic to the scannable flip flops might get electrically unprotected. The challenge is that so called scan stitching only happens in the Back-End. As a result, Front-End cannot code isolation strategies beforehand. For this reason, isolation strategies conventionally need to be coded as part of the incremental Unified Power Format (UPF) in Back-End.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a flow diagram of a design and manufacturing process of an integrated circuit;

FIG. 2 shows an example of a scannable flip flop;

FIG. 3 shows an example of a stitching of flip flops/latches into a scan chain;

FIG. 4 shows a system in accordance with various aspects of this disclosure;

FIG. 5 shows a block diagram illustrating the addition of electrically unprotected interconnections between different power plane domains in accordance with various aspects of this disclosure;

FIG. 6 shows a flow diagram illustrating the formation of the DFT structure in accordance with various aspects of this disclosure in more detail;

FIG. 7 shows a flow diagram illustrating the formation of the DFT structure in accordance with various aspects of this disclosure in more detail;

FIG. 8 shows a flow diagram illustrating the formation of the DFT structure in accordance with various aspects of this disclosure in more detail; and

FIG. 9 shows a flow diagram illustrating the formation of the DFT structure in accordance with various aspects of this disclosure.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various aspects of this disclosure provide an efficient way to implement isolation strategies for DFT enabled Multi Power Plane Designs. Furthermore, various aspects of this disclosure include an automated method for implementing isolation strategies when inserting low power sells for DFT-enabled multi power plane designs, rather than relying on manual isolation strategies.

A system on chip may have one or more connections between a DFT control logic (also referred to as DFT control circuit) and flip flops (or other combinational logic) in a multi power plane design. The one or more connections may be electrically unprotected due to multi power plane crossing(s) (also referred to as power domain crossing(s)), potentially leading to functional failure. To safeguard this or these connections, low power cells need to be added at multi power plane crossings. To achieve this, reference isolation strategies are received from RTL that are applicable to a respective DFT crossing. Once received, these reference isolation strategies may be filtered based on clamp values (which are associated with the reference isolation strategies) of logic “0” and logic “1”. In the next step, isolation strategies with clamp value “0” may be uniquified based on the isolation_enable signal provided to a respective isolation strategy. An isolation_enable signal is a control signal that ensures a known value from “off” to “on” on the power plane crossing. After obtain these new strategies, the next step may involve the automatic addition of low-power cells (selected from the suitable reference isolation strategies).

Illustratively, the method may include that reference isolation strategies are received from RTL that are applicable to DFT crossing. Once received, these reference isolation strategies may be filtered based on clamp values of logic “0” and logic “1”. In the next step, isolation strategies with clamp value logic “0” are uniquified based on an isolation_enable signal. The isolation_enable signal is a control signal that passes a known value from “off” to “on” on the power domain crossing. After obtaining these new isolation strategies, the next step involves the automatic addition of low-power cells into the DFT.

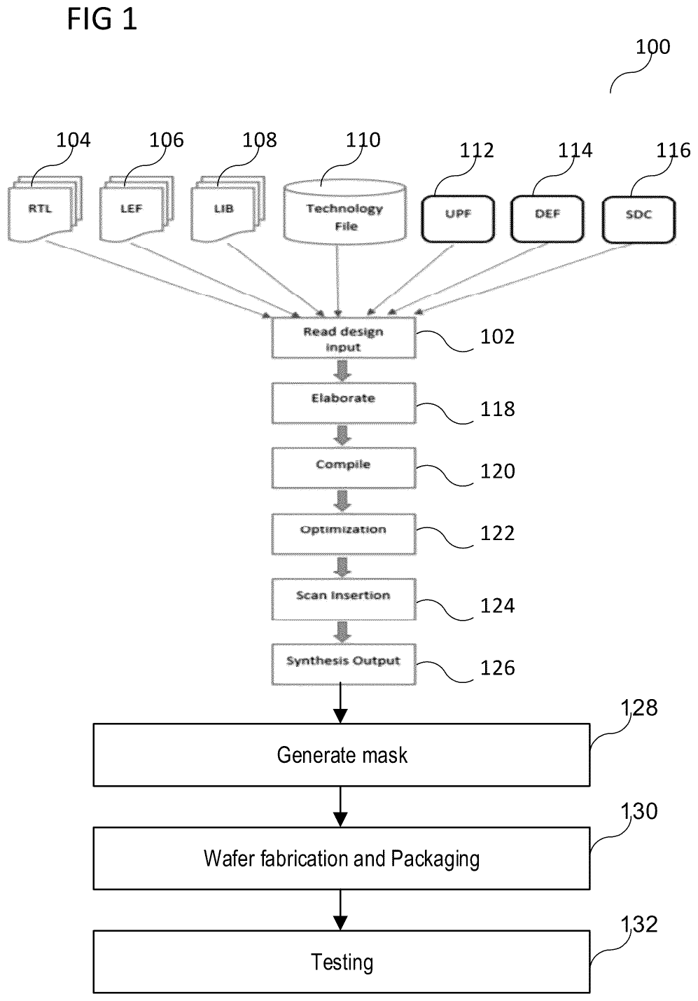

FIG. 1 shows a flow diagram 100 of a design and manufacturing process of an integrated circuit.

The design and manufacturing process of an integrated circuit may start, in 102, with at least one processor reading design input from various circuit design descriptions. The at least one processor may include one or more processors, which may be located at a common location or at various different locations, which may be connected via a local communication network (e.g. a local area network (LAN)) and/or via a Wide Area Network (WAN). Various aspects of the integrated circuit to be manufactured may be described and defined using various formats, such as:
A Register Transfer Level (RTL) description 104:
RTL is a design description which models a synchronous digital circuit in terms of the flow of digital signals (data) between hardware registers, and the logical operations performed on those signals. Register-transfer-level description is used in hardware description languages (HDLs) like Verilog and VHDL to create high-level representations of a circuit, from which lower-level representations and ultimately actual wiring can be derived. RTL description may specify a plurality of RTL modules, which may be located in a plurality of different power plane domains in a multi power plane design.
A Library Exchange Format (LEF) description 106:
LEF is a specification for representing the physical layout of an integrated circuit in an ASCII format. It includes design rules and abstract information about standard cells.
A Liberty (LIB) description 108:
LIB defines Process, Voltage, Temperatur (PVT), timing, power, noise, and other characteristics of cell library.
A technology file 110:
The technology file provides information on various aspects, including layer definitions, design rules, spacing requirements, wire widths, and other parameters that guide the layout of the integrated circuit.
A Unified Power Format (UPF) description 112:
UPF outlines design power intent, specifying control signals, routing, block configuration, and more. UPF is a standard for specifying power intent in power optimization of electronic design automation by the Institute of Electrical and Electronic Engineers (IEEE), e.g. IEEE 1801-2018. UPF description 112 may specify electronic components to be located in different power plane domains. By way of example, the electronic components in a respective power plane domain may be dimensioned to operate with the supply voltage provided in the respective power plane domain. UPF description 112 may include voltage requirements for an IC to be manufactured in a multi power plane design.
A Design Exchange Format (DEF) description 114:
DEF represents the netlist and circuit layout.
A Synopsys Design Constraints (SDC) description 116:
SDC is used to specify the design intent, including timing, power and area constraints for a design of the integrated circuit. SDC is used by different EDA tools to synthesize and analyse a design of the integrated circuit.

The above explained specifications 104, 106, 108, 110, 112, 114, 116 can be stored in one or more files or in any other desired manner. The specifications 104, 106, 108, 110, 112, 114, 116 may be stored centrally by a host or server computer, for example. As an alternative, the specifications 104, 106, 108, 110, 112, 114, 116 may be stored decentrally, i.e. in a distributed manner, by a plurality of host or server computers, for example.

Illustratively, the processor uses the specifications 104, 106, 108, 110, 112, 114, 116 to define specifications and requirements of the integrated circuit to be manufactured. The specifications 104, 106, 108, 110, 112, 114, 116 may describe and specify e.g. a circuit diagram, which may include various electronic components, such as transistors, resistors, capacitors and interconnections between the same. The processor may implemented this process using e.g. so called Electronic Design Automation (EDA) software.

The processor may, in 118, elaborate the read design input. In an example, the read design input may include an RTL and UPF description, in the following also referred to as RTL-UPF description. Then, the processor may, in 120, compile the elaborated design. Furthermore, the processor may, in 122, optionally optimize the design and layout of the compiled design. In order to allow testability of the manufactured chip, e.g. a system on chip (SoC), the processor may, in 124, generate a Design for Test (DFT) using the (optionally optimized) compiled design. By way of example, the processor performs a so called scan chain insertion. The scan chain insertion may involve the following two steps:

1) Flip flops/latches replacement with scannable versions thereof. Furthermore, a scan control logic is added to the (optionally optimized) compiled design and will thus become part of the DFT structure.

2) Stitching flip flops/latches in the scan chains.

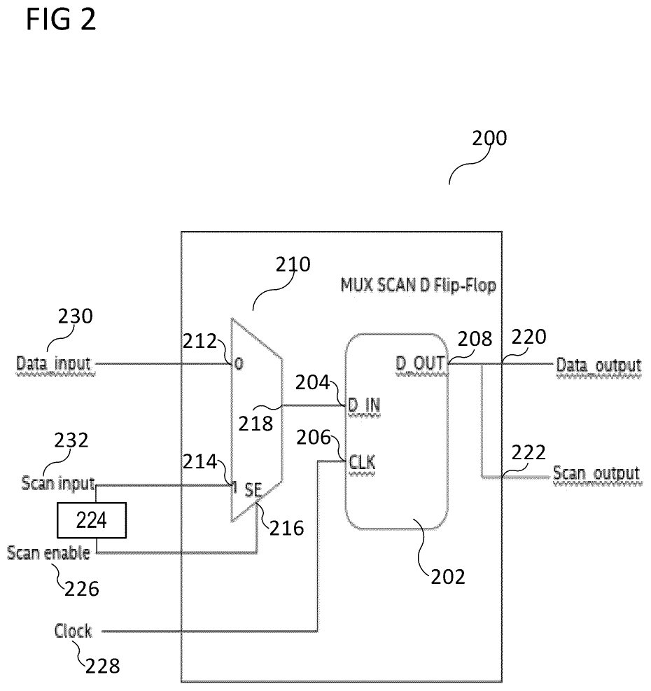

FIG. 2 shows an example of a scannable flip flop/latch 200 (in the following also referred to as flop). The scannable flip flop 200 may include a flip flop 202, e.g. a (e.g. edge triggered) D flip flop 202 having a D flip flop data input 204, a D flip flop clock input 206 and a D flip flop data output 208. The scannable flip flop 200 may further include a multiplexer 210 having a data input 212, a scan input 214, a scan enable input 216 and a multiplexer output 218 which may be directly coupled to the D flip flop data input 204 of the D flip flop 202. The scannable flip flop 200 may further include a data output 220 and a scan output 222.

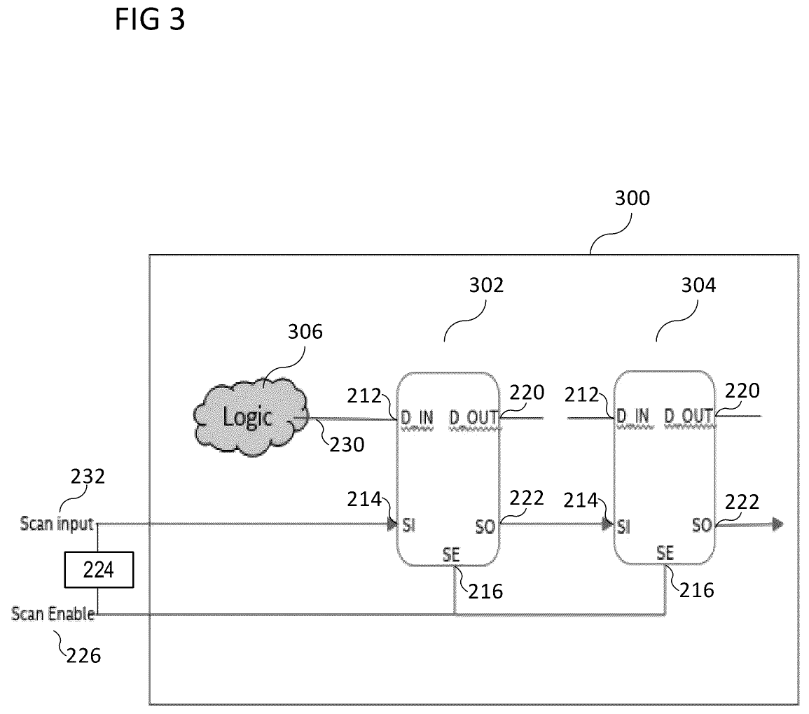

FIG. 3 shows an example of a stitching of flip flops/latches into a scan chain 300. FIG. 3 shows two scannable flip flops, a first scannable flip flop 302 and a second scannable flip flop 304. Both scannable flip flops 302, 304 may have the same structure as the scannable flip flop 200 from FIG. 2 (therefore, the same reference numbers are used in FIG. 3).

The scan chain 300 may operate in two modes:

1) Firstly, the scan chain 300 may operate in a functional mode, which illustratively is the normal operation mode in which the scan chain 300 may be ignored. In the functional mode, a scan control logic 224 provides a scan enable signal 226 having a logic “0” level to the scan enable input 216, thereby selecting the data input 212 to connect to the multiplexer output 218 and thus to the D flip flop data input 204 which will, depending on a clock signal 228 that a clock signal generator (not shown) applies to the D flip flop clock input 206, be forwarded to the D flip flop data output 208. Thus, a data input signal 230, a logic 306 applies to the data input 212 will be provided at the D flip flop data output 208 and also at the data output 220. Any signal present at the scan input 214 will be ignored.

2) Secondly, the scan chain 300 may operate in a test mode. In the test mode, the scan control logic 224 provides the scan enable signal 226 having a logic “1” level to the scan enable input 216, thereby selecting the scan input 214 to connect to the multiplexer output 218 and thus to the D flip flop data input 204 which will, depending on the clock signal 228, be forwarded to the D flip flop data output 208 and then to the scan output 222. In the test mode, the scan control logic 224 furthermore, provides a scan input signal 232, in other words, a sequence of sequential elements (by way of example, each sequential element is a bit value, e.g. logic “0” or logic “1”), to the scan input 214. Each sequential element is loaded with a known value, then the scan control logic 224 controls the scan chain 300 to operate in the normal mode for one clock cycle of the clock signal 228 to capture the outcome of combinational logic components. Afterwards, the scan chain 300 returns to the test mode (also referred to as scan mode) to shift out this outcome.

The scan control logic 224, which generates and controls the sequential elements for the scan chain 300, i.e. the scan input signal 232, is located at a dedicated hierarchy within the DFT. The voltage requirements in multi power plane designs include a plurality of different supply voltages and a plurality of power plane domains operating with different supply voltages (e.g. a first supply voltage of 1.5 V, a second supply voltage of 3 V, and a third supply voltage of 5 V, or the like). The scan control logic 224 may operate at a different primary supply voltage than the connected scan chain 300. In other words, the scan control logic 224 and the scan chain 300 may be located in different power plane domains. Furthermore, scannable flip flops may be located in different power plane domains. This may cause a multiple power planes design challenge, since also interconnections between the newly inserted scan control logic 224 and the also newly inserted scan chain 300 may cross different power plane domains. Furthermore, scannable flip flops 302, 304 of the scan chain 300 may be interconnected via an interconnection crossing different power plane domains. The newly added interconnection(s) will also be referred to as power domain crossing(s). Thus, a multi-voltage design violation may occur between the interface of the scan control logic 224 and a connected scannable flip flop 302, 304 of the scan chain 300 or between connected scannable flip flops located in different power plane domains. In other words, multi-voltage designs are forcing a power domain crossing between scan control logic (also referred to as DFT control logic 224) to a connected scannable flip flop 302, 304 of the scan chain 300. The added power domain crossing(s) may get electrically unprotected. For this reason, isolation strategies (in other words added isolation regions, also referred to as isolation logic or isolation cells) need to be encoded as part of the UPF at this stage. However, conventionally, these isolation regions can only be encoded in the Front-End, as described above. Since the additional electrically unprotected power domain crossings are added in process 124, i.e. in the Back-End, when forming the DFT, there is no conventional automatic way to protect the unprotected power domain crossings in the DFT.

Various aspects of this disclosure provide a mechanism for Back-End implementation tools, solving this problem which allows automatic insertion of Low-power (also referred to as LP) cells (which are an implementation of isolation regions) on DFT induced power domain crossing(s). This mechanism will be explained in more detail below.

Referring back to FIG. 1, the process continues in 124, in the processor performs a synthesis of the DFT and outputs the same.

The process may further include, in 128, a mask generation process. The mask generation includes a generation of masks based on the synthesized design and layout. Masks are patterns defining the shapes and locations of various features on the chip to be manufactured. The masks will be used in fabrication to physically transfer the DFT onto a wafer, e.g. a silicon wafer.

The process may then continue in 130, which include wafer fabrication and packaging. Wafer fabrication uses the masks to generate the desired pattern on the wafer, which involves a plurality of different manufacturing processes, such as e.g. depositing and etching various layers, doping and e.g. generating transistor structures. Wafer fabrication may include fabrication of multiple integrated circuits (ICs) on a single wafer. Once the wafer fabrication is completed, the process may include singularizing and packaging the ICs into a suitable housing to protect the ICs and electrical connections. Packaging may also include attaching of leads or balls for IC external connection.

Finally, the process may include, in 132, testing of the manufactured and packaged IC, e.g. using the scan control logic 224 and the scan chain 300 as described above. The packaged ICs may undergo various electrical tests to meet the design specification. Testing may include functional verification, performance evaluation and reliability assessments, for example.

It is to be noted that one or more processors may implement the software based processes 102, 118, 120, 122, 124, 126 using a variety of different software tools specialized for the respective process.

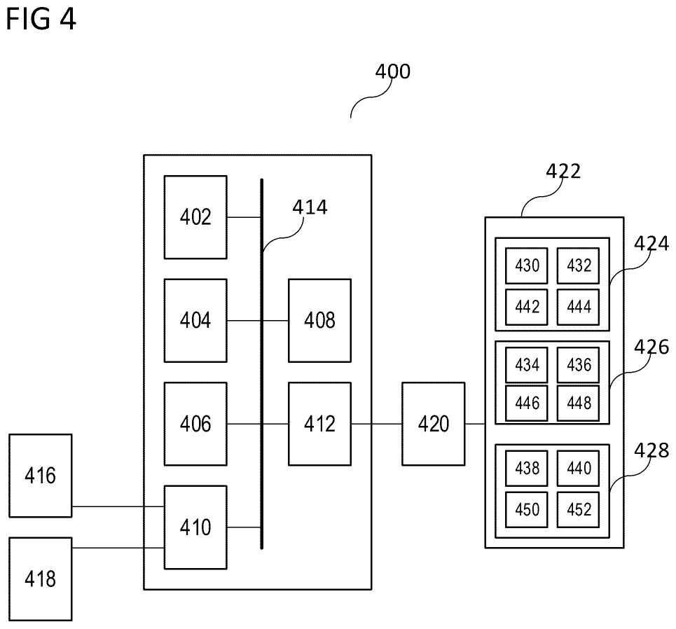

FIG. 4 shows a system 400 having a processor 402, a main memory 404, a read only memory (ROM) 406, which may store instructions to implement the methods as previously described and the methods which will be explained in more detail below), a storage device 408, an input/output (I/O) interface 410 and one or more communication interfaces 412. These components may be coupled to each other via bus 414.

External devices such as one or more input devices (such as a keyboard, a mouse, a microphone, and the like) 416 and/or one or more output devices (such as a display, a loudspeaker, and the like) 418 may be coupled to the I/O interface 410.

Furthermore, system 400 may include one or more servers 420 communicatively coupled (e.g. via communication network such as the Internet) to the one or more communication interfaces 412. The one or more servers 420 may provide various software tools to the processor for implementing or supporting the processes as described with reference to FIG. 1. The software tools (also referred to as software programs) may include Electronic Design Automation (EDA) software, Hardware Design Language tools (e.g. editors (e.g. VHDL, Verilog), libraries (e.g. VHDL, Verilog)) or Hardware Design Language compiler, and the like. The tools and/or the libraries may be stored in one or more databases 422 coupled to the one or more servers 420. By way of example, the one or more databases 422 may store RTL-UPF descriptions 424, 426, 428 which may include a plurality of RTL modules 430, 432, 434, 436, 438, 440 as well as various RTL isolation strategies 442, 444, 446, 448, 450, 452 (also referred to as RTL isolation cells) for different requirements, e.g. for different voltage requirements.

The following shows an example RTL isolation strategy (RTL isolation cell) in VHDL:
set_isolation HIER_TR
   domain PD_A
   isolation_supply_set SS_EN
   isolation_signal EN
   isolation_sense low
   clamp value 0
   location self
   elements {A_H B_H}

As already outlined above, in the process 124 of generating the DFT, a scan control logic, scannable flip flops forming a scan chain as well as electrically unprotected power domain interconnections (power domain crossings) between the scan control logic and one or more of the scannable flip flops or between scannable flip flops located in different power plane domains, are added to the RTL-UPF description and the UPF requirements included in the RTL-UPF description.

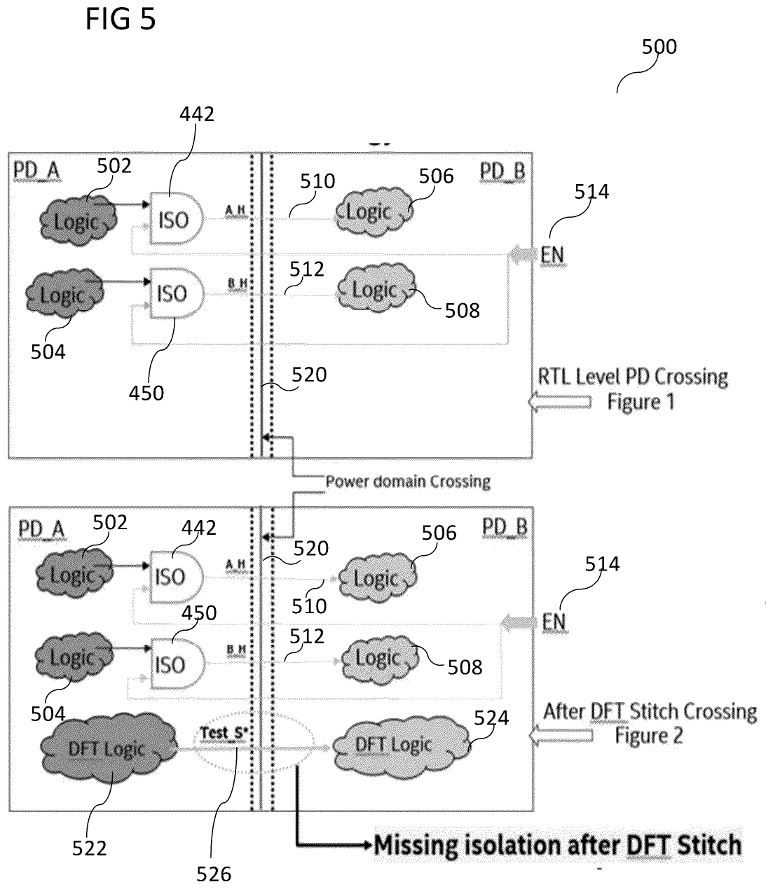

FIG. 5 shows a block diagram 500 illustrating the addition of electrically unprotected interconnections between different power plane domains during the generating of the DFT (in 124).

FIG. 5 exemplarily shows two power plane domains, a first power plane domain PD_A and a second power plane domain PD_B. The first power plane domain PD_A may be a low power (LP) power plane domain (which may e.g. be switched off or switched into a low power operation mode during operation of the IC to be manufactured), and the second power plane domain PD_B may be a power plane domain, which is usually still switched on even if the first power plane domain PD_A is switched off.

The upper portion of FIG. 5 shows both power plane domains representing the RTL modules and the lower portion of FIG. 5 shows both power plane domains representing the DFT structure, i.e. a graphical simplified representation of the DFT as determined in 124 of FIG. 1, however, still having an electrically unprotected power domain crossing between the first power plane domain PD_A and the second power plane domain PD_B. Furthermore, FIG. 5 also shows a voltage (power) domain crossing 520, which represents a power plane domain separation between the first power plane domain PD_A and the second power plane domain PD_B.

A first logic 502 and a second logic 504 are located in the first power plane domain PD_A and a third logic 506 and a fourth logic 508 are located in the second power plane domain PD_B. The first logic 502 is connected to the third logic 506 via a first interconnection 510 between the first power plane domain PD_A and the second power plane domain PD_B. The second logic 504 is connected to the fourth logic 508 via a second interconnection 512 between the first power plane domain PD_A and the second power plane domain PD_B. The first interconnection 510 and the second interconnection 512 are electrically protected (on RTL level) using RTL isolation strategies or regions (RTL isolation cells), e.g. taken from the RTL isolation strategies 442, 444, 446, 448, 450, 452. By way of example, first interconnection 510 is electrically protected using a first RTL isolation cell 442 to ensure a defined voltage level on the first interconnection 510, even if the first logic 502 is switched off, thereby avoiding a floating voltage level on the first interconnection 510. Furthermore, the second interconnection 512 may be electrically protected using a second RTL isolation cell 450 to ensure a defined voltage level on the second interconnection 512, even if the second logic 504 is switched off, thereby avoiding a floating voltage level on the second interconnection 514. In other words, the first interconnection 510 and the second interconnection 512 are examples of RTL level power plane domain crossings that are protected by a respective RTL isolation cell. An isolation cell enable signal EN 514 may enable or disable (dependent on the state of the isolation cell enable signal EN 514) the respective RTL isolation cells 442, 450. By way of example, the isolation cell enable signal EN 514 will enable the first RTL isolation cell 442 and the second RTL isolation cell 450 in case the first logic 502 and the second logic 504 are switched off or are set into a low power mode so that, without the isolation protection, a floating voltage may occur on the first interconnection 510 and the second interconnection 512, respectively.

At least one RTL-UPF isolation rule of the plurality of RTL-UPF isolation rules may describe an isolation cell having an OR-gate, a first input of the OR-gate is to be connected to a first terminal of a respective power domain crossing, wherein the first terminal is located in the first power plane domain (e.g. a LP power plane domain), a second input of the OR-gate is to be connected to a terminal receiving an isolation cell enable signal, and an output of the OR-gate is to be connected to a second terminal of a respective power domain crossing, wherein the second terminal is located in the second power plane domain (e.g. a power plane domain which is always “on”). In various aspects of this disclosure, a clamp value associated with an OR gate is logic “1”.

At least one RTL-UPF isolation rule of the plurality of RTL-UPF isolation rules may describe an isolation cell having an AND-gate, a first input of the AND-gate is to be connected to a first terminal of a respective power domain crossing, wherein the first terminal is located in the first power plane domain (e.g. a LP power plane domain), a second input of the AND-gate is to be connected to a terminal receiving an isolation cell enable signal, and an output of the AND-gate is to be connected to a second terminal of a respective power domain crossing, wherein the second terminal is located in the second power plane domain (e.g. a power plane domain which is always “on”). In various aspects of this disclosure, a clamp value associated with an AND gate is logic “0”.

As described above, when generating the DFT, DFT logic, e.g. scannable flip flops and/or scan control logic 224 may be inserted into the design, i.e. the RTL modules (after the RTL isolation cells have already been inserted into the RTL modules). The bottom portion of FIG. 5 illustrates this by exemplarily showing a first DFT logic 522 located in the first power plane domain PD_A and a second DFT logic 524 located in the second power plane domain PD_B. Connecting one or more electronic components (such as e.g. one or more scannable flip flops) of the first DFT logic 522 with one or more electronic components (such as e.g. one or more scannable flip flops) of the second DFT logic 524, e.g. to form a scan chain extending from the first power plane domain PD_A to the second power plane domain PD_B, creates additional power plane domain crossings, e.g. a third interconnect 526 in the DFT structure. This third interconnect 526 is electrically unprotected. By way of example, if the first power plane domain PD_A is switched off, an unknown (floating) potential may occur at the third interconnect 526.

Therefore, process 124, further includes a process to electrically protect such electrically unprotected power domain crossings in the DFT after having completed a part of the scan insertion.

In this context, it is to be noted, that e.g. level shifters to protect e.g. the first interconnection 510 or the second interconnection (as an alternative measure to the isolation cells 442, 450 as shown in FIG. 5) may be inserted automatically by an EDA tool, yet isolation cell insertion requires UPF strategies which are described in accordance with RTL UPF. As already briefly explained above, scan paths (or scan chains) including a plurality of scannable flip flops, are introduced only during Back-End (i.e. when generating the DFT) and may cause multi-voltage violations that could not be predicted in a former stage such as in the RTL-UPF description. In accordance with various aspects of this disclosure, scan related UPF strategies are generated only after scan insertion process in the Back-End design flow.

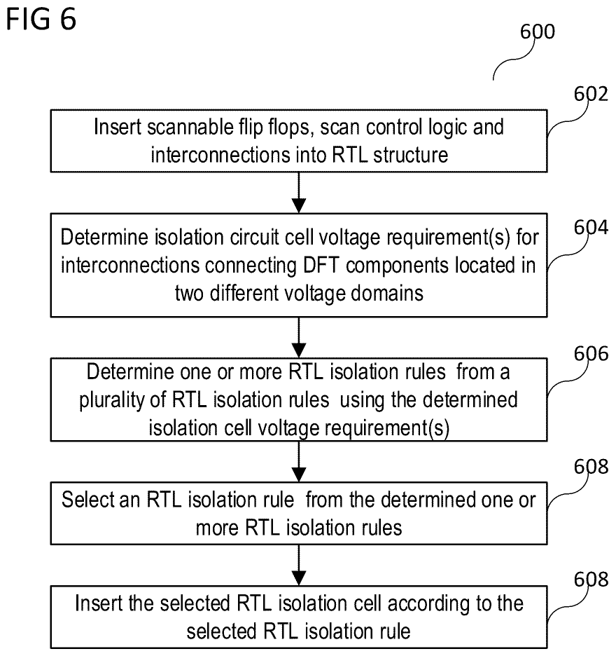

FIG. 6 shows a flow diagram 600 illustrating the generating the DFT (process 124 in FIG. 1) in more detail. In various aspects of this disclosure, the processor 402 is configured to implement and perform the algorithm according to flow diagram 600 of FIG. 6.

In 602, the process includes inserting DFT components such as scannable flip flops, a scan control logic, and corresponding interconnections (to connect e.g. the inserted scannable flip flops with each other and/or to connect the scan control logic with the inserted scannable flip flops) into the RTL-UPF description.

In 604, the process includes determining an isolation cell requirement for the inserted interconnections (also referred to as power domain crossings), e.g. only for those interconnections which connect a DFT component located in one power plane domain (e.g. a low voltage (power) domain, e.g. a power plane domain operating with a low supply voltage, e.g. of 1 V to 3 V) with another DFT component located in another power plane domain (e.g. a high voltage (power) domain, e.g. a power plane domain operating with a supply voltage being higher than the low supply voltage, e.g. of 4 V to 6 V, e.g. 5 V). By way of example, the isolation cell requirement for an interconnect (power domain crossing) may include a driver voltage requirement for a first terminal (e.g. first pin) of the interconnection, wherein the first terminal is located in the low power plane domain (which may sometimes temporarily switched off to save energy), e.g. the first power plane domain PD_A, and a load voltage requirement for the other (second) terminal (e.g. second pin) of the interconnection, wherein the second terminal is located in the high power plane domain (which is always on), e.g. the second power plane domain.

Using the determined isolation cell requirement(s) for the inserted interconnections, the algorithm may search, in 606, for suitable RTL isolation strategies (RTL-UPF isolation cells, also referred to as RTL-UPF isolation rules) 442, 444, 446, 448, 450, 452 stored in the one or more databases 422. In this case, the algorithm 402 may search for suitable values in the parameter “-elements {A_H B_H}” as explained in the VHDL example above.

Then, in 608, the algorithm may select an RTL isolation rule from the determined suitable RTL isolation rules for each of the inserted interconnections for which an isolation cell requirement had been determined in 604. The algorithm 402 may adjust the parameter values of the selected RTL isolation rule in accordance with potential requirement(s) for the DFT structure (by way of example, a clamp value may be changed to a target clamp value desired in the DFT).

The algorithm may finally, in 610, insert the selected (if applicable also adapted) RTL isolation cell according to the selected (and potentially adjusted) RTL isolation rule into the DFT structure.

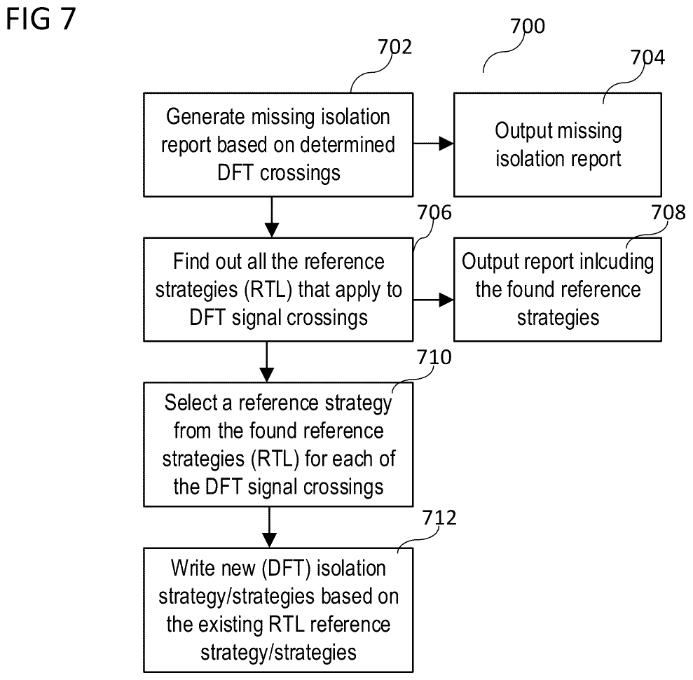

FIG. 7 shows a flow diagram 700 illustrating the generating the DFT in accordance with various aspects of this disclosure. The method may be implemented by the processor 402.

In 702, the algorithm, using a software tool, determines the DFT interconnections (DFT power domain crossings) inserted in the generation of the DFT, which are electrically unprotected and which are power domain crossing from one power plane domain (e.g. low power (LP) power plane domain) to another power plane domain. The method includes generating a missing isolation report, which includes the determined interconnections (power domain crossings). Optionally, the algorithm 402 may output the missing isolation report to a user (block 704).

Then, in 706, the algorithm determines (in other words finds out) all RTL reference strategies (in other words, all RTL isolation strategies (also referred to as RTL-UPF isolation rules or RTL isolation cells) that apply to the DFT (signal) power domain crossings, i.e. the DFT interconnections that cross from one power plane domain to another power plane domain and e.g. thereby causing a multi-voltage design violation. The algorithm 402 optionally may generate a report including the determined RTL reference strategies and may output the report to a user for reference (block 708).

Then, in 710, the algorithm selects a RTL reference strategy from the found RTL reference strategies for each of the DFT signal power domain crossings.

Then, in 712, the algorithm, if required, amends the selected RTL reference strategy to thereby generate a DFT isolation strategy (in other words, a DFT isolation region or DFT isolation cell) and inserts (writes) the generated DFT isolation strategy into the DFT, e.g. in the associated UPF file. In other words, the algorithm 402 may write new DFT isolation strategies based on the existing RTL reference strategies.

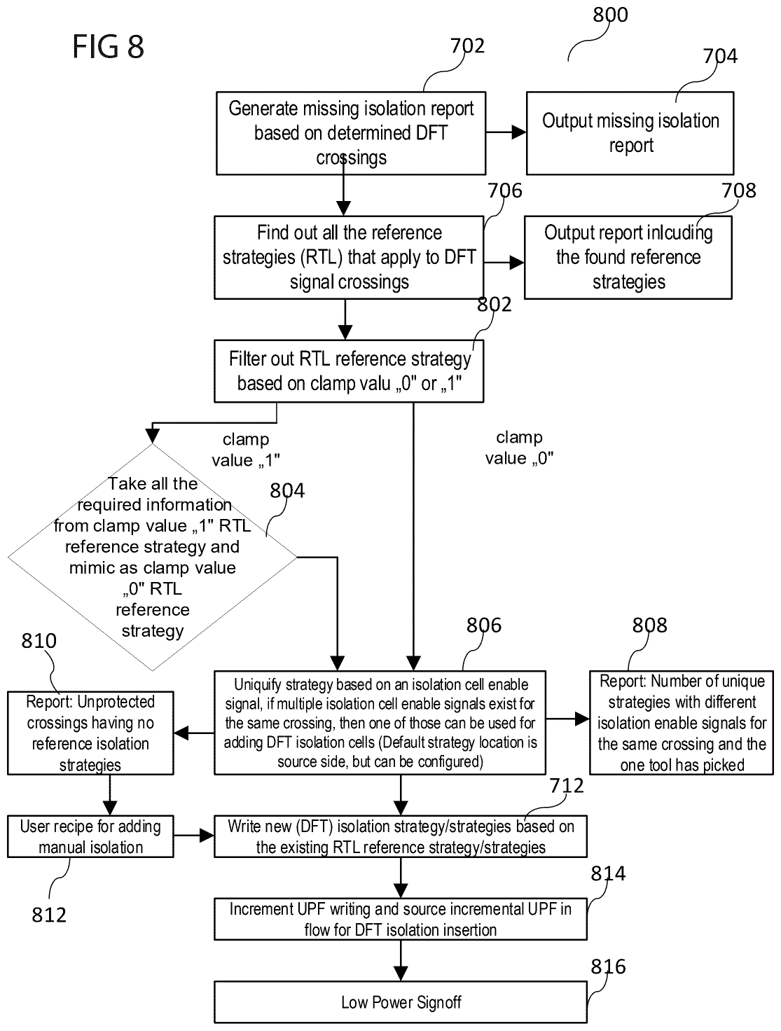

FIG. 8 shows a flow diagram 800 illustrating the generation of the DFT in accordance with various aspects of this disclosure. The method may be implemented by the processor 402. The method is similar to the method of FIG. 7 and includes various optional additional processes.

In this method, the algorithm may, in 802, after having found all the RTL reference strategies that apply to DFT signal power domain crossings (e.g. all the RTL-UPF isolation rules or RTL-UPF isolation cells that fulfil the above explained RTL isolation cell requirement(s)).

In case the DFT structure requires a clamp value “0” (e.g. according to an architectural design requirement) for the isolation cells inserted into the DFT, the processor 402 may, in 804, e.g. change the clamp value for all the found RTL reference strategies having a clamp value “1” to the desired/required clamp value “1”. In other words, process 804 may include to take all the required information from an RTL reference strategy having a clamp value “1” and mimic the same as an RTL reference strategy having a clamp value “0”.

Furthermore, the algorithm may, after completing process 802 for the found RTL reference strategies having the clamp value “0” or after completing process 804 for the found RTL reference strategies having the clamp value “1”, in 806, uniquify a respective strategy based on an isolation cell enable signal, if multiple isolation cell enable signals exist for the same power domain crossing, then one of those can be used for adding DFT isolation cells (Default strategy location is source side, but can be configured). Illustratively, the algorithm 402 may select a plurality of isolation cell enable signals and combine at least some of them, if possible.

The algorithm optionally, in 808, may generate a report indicating a number of unique DFT isolation strategies with different isolation cell enable signals for the same interconnect (power domain crossing) and the software tool executed by the algorithm 402, has picked, and may output the report to a user.

The algorithm optionally, in 810, may generate a further report indicating those power domain crossings which are still electrically unprotected, in other word those power domain crossings which still have no reference isolation strategy. A user may, in 812, use a user recipe for adding manual isolation cell(s).

Furthermore, the algorithm may, after completing process 806 or after completing process 812, in 712, write new DFT isolation strategies based on the existing RTL reference strategies.

The process then may continue in 814, in which the algorithm 402 may increment a UPF writing and source incremental UPF in the flow for the DFT isolation cell insertion, and, in 816, in which 402 may perform a low power signoff.

Illustratively, the above aspects of a DFT low power cells insertion algorithm may include:

1) Find all applicable RTL reference strategies from a software tool dumped unprotected power domain crossings report based on the associated clamp value.

2) Flip the clamp value from “1” to “0” (or from “0” to “1” if desired or required) if all RTL reference strategies have an associated clamp value “1”, though the user has the flexibility to choose the desired clamp value.

3) From the suggested RTL reference strategies, the algorithm may uniquify them based on isolation enable signals and further may pick one of them by default for a particular power domain crossing unless the user intervenes (e.g. manually).

4) Location of a respectively selected RT reference strategy is also configurable in case of a mix of source and sink RTL reference strategies.

5) Output may be a set of unique isolation strategies covering all DFT induced power domain crossings.

6) The flow runs using this output incremental strategy set unless the user adds his custom strategy list.

It is to be noted that the computer-implemented automatic method in accordance with various aspects of this disclosure is taking part right after the scan insertion stage. It relies on the assumption that the examined network is homogeneous, meaning—each hierarchical pin that is used in isolation strategies drives pins that are related to the same power supply. If this is not the case, the insertion may generate a new multi-voltage violation. Additionally, this solution is process independent (i.e. independent from the manufacturing processes used in a fab). Illustratively, it may contain three main parts:

1) Tool parsing of functional power domain crossing-based strategies from front-end UPF.

2) Read applicable strategy set, uniquify and apply on DFT induced power domain crossings.

3) Insert low power cells (isolation/level shifter) and verify with low power signoff tool.

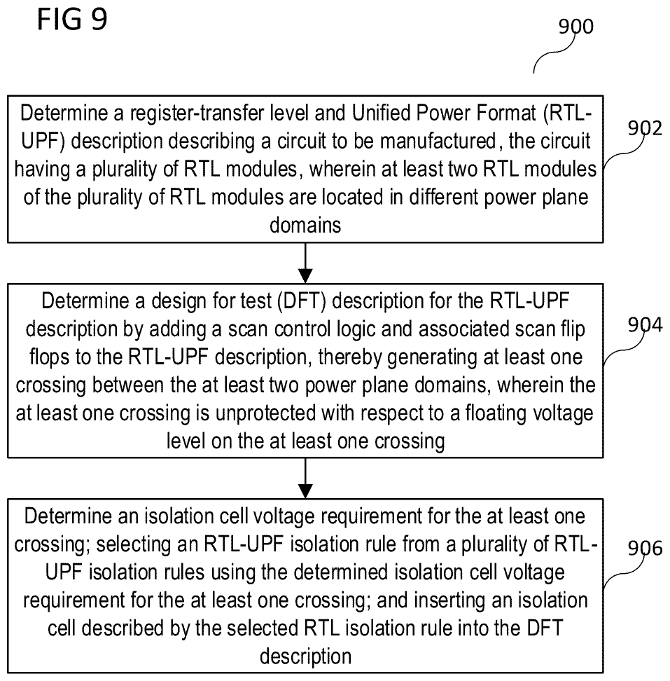

FIG. 9 shows a flow diagram illustrating the formation of the DFT structure in accordance with various aspects of this disclosure.

The method may include, in 902, determining a register-transfer level and Unified Power Format (RTL-UPF) description describing a circuit to be manufactured, the circuit having a plurality of RTL modules, wherein at least two RTL modules of the plurality of RTL modules are located in different power plane domains. The method may further include, in 904, determining a design for test (DFT) description for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing. The method may further include, in 904, determining an isolation cell requirement for the at least one power domain crossing; selecting an RTL-UPF isolation rule from a plurality of RTL-UPF isolation rules using the determined isolation cell requirement for the at least one power domain crossing; and inserting an isolation cell described by the selected RTL isolation rule into the DFT description.

In the following, various aspects of this disclosure will be illustrated:

Example 1A is a system. The system may include a memory storing instructions which, when executed by a processor, implement a method; and a processor configured to: determine a register-transfer level and Unified Power Format (RTL-UPF) description describing a circuit to be manufactured, the circuit including a plurality of RTL modules, wherein at least two RTL modules of the plurality of RTL modules are located in different power plane domains, determine a design for test (DFT) for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing; determine an isolation cell requirement for the at least one power domain crossing; select an RTL-UPF isolation rule from a plurality of RTL-UPF isolation rules using the determined isolation cell requirement for the at least one power domain crossing; and insert an isolation cell described by the selected RTL isolation rule into the DFT.

In Example 2A, the subject matter of Example 1A can optionally include that the isolation cell requirement includes at least one of a driver voltage requirement of a first terminal of a respective power domain crossing, wherein the first terminal is located in a first power plane domain, or a load voltage requirement of a second terminal of the respective power domain crossing, wherein the second terminal is located in a second power plane domain.

In Example 3A, the subject matter of Example 2A can optionally include that at least one RTL-UPF isolation rule of the plurality of RTL-UPF isolation rules describes an isolation cell including an OR-gate, a first input of the OR-gate is to be connected to a first terminal of a respective power domain crossing, wherein the first terminal is located in the first power plane domain, a second input of the OR-gate is to be connected to a terminal receiving an isolation cell enable signal, and an output of the OR-gate is to be connected to a second terminal of a respective power domain crossing, wherein the second terminal is located in the second power plane domain.

In Example 4A, the subject matter of Example 3A can optionally include that a clamp value associated with the OR gate is logic “1”.

In Example 5A, the subject matter of any one of Examples 2A to 4A can optionally include that at least one RTL-UPF isolation rule of the plurality of RTL-UPF isolation rules describes an isolation cell including an AND-gate, a first input of the AND-gate is to be connected to a first terminal of a respective power domain crossing, wherein the first terminal is located in the first power plane domain, a second input of the AND-gate is to be connected to a terminal receiving an isolation cell enable signal, and an output of the AND-gate is to be connected to a second terminal of a respective power domain crossing, wherein the second terminal is located in the second power plane domain.

In Example 6A, the subject matter of Example 5A can optionally include that a clamp value associated with the AND-gate is logic “0”.

In Example 7A, the subject matter of any one of Examples 1A to 6A can optionally include that each RTL-UPF isolation rule from the plurality of RTL-UPF isolation rules includes an associated pre-defined clamp value. The method may further include: determining, if the pre-defined clamp value of a respective RTL-UPF isolation rule is equal to a pre-defined target clamp value; in case that the pre-defined clamp value is not equal to the pre-defined target clamp value, replacing the pre-defined clamp value by the pre-defined target clamp value.

In Example 8A, the subject matter of any one of Examples 1A to 7A can optionally include that each RTL-UPF isolation rule from the plurality of RTL-UPF isolation rules includes an associated pre-defined clamp value. The RTL-UPF isolation rule is selected from only those RTL-UPF isolation rules of the plurality of RTL-UPF isolation rules, in which the associated pre-defined clamp value is equal to a pre-defined target clamp value.

In Example 9A, the subject matter of any one of Examples 1A to 8A can optionally include that the isolation cell requirement is included in a Unified Power Format (UPF) description.

In Example 10A, the subject matter of any one of Examples 5A to 9A can optionally include that the design for test (DFT) description for the RTL-UPF description is determined by adding a scan control logic and associated scan flip flops to the RTL-UPF description, thereby generating at least two power domain crossings between the at least two RTL modules of the plurality of RTL modules, wherein the at least two power domain crossings are unprotected with respect to a floating voltage level on each of the at least two power domain crossing. An isolation cell requirement is determined for each of the at least two power domain crossings. An RTL-UPF isolation rule from the plurality of RTL-UPF isolation rules is selected using the determined isolation cell requirement for each of the at least two power domain crossings. The isolation cells described by the selected RTL-UPF isolation rules are inserted into the DFT structure. The inserted isolation cells share the same isolation cell enable signal.

In Example 11A, the subject matter of any one of Examples 1A to 10A can optionally include that the system further includes one or more devices configured to manufacture the circuit in accordance with the DFT structure including the inserted isolation cell.

Example 1B is a non-transitory computer readable medium storing instructions which, when executed by a processor, implement a method. The method may include: determining a register-transfer level and Unified Power Format (RTL-UPF) description describing a circuit to be manufactured, the circuit including a plurality of RTL modules, wherein at least two RTL modules of the plurality of RTL modules are located in different power plane domains, determining a design for test (DFT) description for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing; determining an isolation cell requirement for the at least one power domain crossing; selecting an RTL-UPF isolation rule from a plurality of RTL-UPF isolation rules using the determined isolation cell requirement for the at least one power domain crossing; and inserting an isolation cell described by the selected RTL isolation rule into the DFT description.

In Example 2B, the subject matter of Example 1B can optionally include that the isolation cell requirement includes at least one of a driver voltage requirement of a first terminal of a respective power domain crossing, wherein the first terminal is located in a first power plane domain, or a load voltage requirement of a second terminal of the respective power domain crossing, wherein the second terminal is located in a second power plane domain.

In Example 3B, the subject matter of Example 2B can optionally include that at least one RTL-UPF isolation rule of the plurality of RTL-UPF isolation rules describes an isolation cell including an OR-gate, a first input of the OR-gate is to be connected to a first terminal of a respective power domain crossing, wherein the first terminal is located in the first power plane domain, a second input of the OR-gate is to be connected to a terminal receiving an isolation cell enable signal, and an output of the OR-gate is to be connected to a second terminal of a respective power domain crossing, wherein the second terminal is located in the second power plane domain.

In Example 4B, the subject matter of Example 3B can optionally include that a clamp value associated with the OR gate is logic “1”.

In Example 5B, the subject matter of any one of Examples 2B to 4B can optionally include that at least one RTL-UPF isolation rule of the plurality of RTL-UPF isolation rules describes an isolation cell including an AND-gate, a first input of the AND-gate is to be connected to a first terminal of a respective power domain crossing, wherein the first terminal is located in the first power plane domain, a second input of the AND-gate is to be connected to a terminal receiving an isolation cell enable signal, and an output of the AND-gate is to be connected to a second terminal of a respective power domain crossing, wherein the second terminal is located in the second power plane domain.

In Example 6B, the subject matter of Example 5B can optionally include that a clamp value associated with the AND-gate is logic “0”.

In Example 7B, the subject matter of any one of Examples 1B to 6B can optionally include that each RTL-UPF isolation rule from the plurality of RTL-UPF isolation rules includes an associated pre-defined clamp value. The method may further include: determining, if the pre-defined clamp value of a respective RTL-UPF isolation rule is equal to a pre-defined target clamp value; in case that the pre-defined clamp value is not equal to the pre-defined target clamp value, replacing the pre-defined clamp value by the pre-defined target clamp value.

In Example 8B, the subject matter of any one of Examples 1B to 7B can optionally include that each RTL-UPF isolation rule from the plurality of RTL-UPF isolation rules includes an associated pre-defined clamp value. The RTL-UPF isolation rule is selected from only those RTL-UPF isolation rules of the plurality of RTL-UPF isolation rules, in which the associated pre-defined clamp value is equal to a pre-defined target clamp value.

In Example 9B, the subject matter of any one of Examples 1B to 8B can optionally include that the isolation cell requirement is included in a Unified Power Format (UPF) description.

In Example 10B, the subject matter of any one of Examples 5B to 9B can optionally include that the design for test (DFT) description for the RTL-UPF description is determined by adding a scan control logic and associated scan flip flops to the RTL-UPF description, thereby generating at least two power domain crossings between the at least two RTL modules of the plurality of RTL modules. The at least two power domain crossings are unprotected with respect to a floating voltage level on each of the at least two power domain crossing. An isolation cell requirement is determined for each of the at least two power domain crossings. An RTL-UPF isolation rule from the plurality of RTL-UPF isolation rules is selected using the determined isolation cell requirement for each of the at least two power domain crossings. The isolation cells described by the selected RTL-UPF isolation rules are inserted into the DFT structure. The inserted isolation cells share the same isolation cell enable signal.

In Example 11B, the subject matter of any one of Examples 1B to 10B can optionally include that the non-transitory computer readable medium further stores instructions instructing to manufacture the circuit in accordance with the DFT structure including the inserted isolation cell.

Example 1C is a method. The method may include: determining a register-transfer level and Unified Power Format (RTL-UPF) description describing a circuit to be manufactured, the circuit including a plurality of RTL modules, wherein at least two RTL modules of the plurality of RTL modules are located in different power plane domains, determining a design for test (DFT) description for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing; determining an isolation cell requirement for the at least one power domain crossing; selecting an RTL-UPF isolation rule from a plurality of RTL-UPF isolation rules using the determined isolation cell requirement for the at least one power domain crossing; and inserting an isolation cell described by the selected RTL isolation rule into the DFT description.

In Example 2C, the subject matter of Example 1C can optionally include that the isolation cell requirement includes at least one of a driver voltage requirement of a first terminal of a respective power domain crossing, wherein the first terminal is located in a first power plane domain, or a load voltage requirement of a second terminal of the respective power domain crossing, wherein the second terminal is located in a second power plane domain.

In Example 3C, the subject matter of Example 2C can optionally include that at least one RTL-UPF isolation rule of the plurality of RTL-UPF isolation rules describes an isolation cell including an OR-gate, a first input of the OR-gate is to be connected to a first terminal of a respective power domain crossing, wherein the first terminal is located in the first power plane domain, a second input of the OR-gate is to be connected to a terminal receiving an isolation cell enable signal, and an output of the OR-gate is to be connected to a second terminal of a respective power domain crossing, wherein the second terminal is located in the second power plane domain.

In Example 4C, the subject matter of Example 3C can optionally include that a clamp value associated with the OR gate is logic “1”.

In Example 5C, the subject matter of any one of Examples 2C to 4C can optionally include that at least one RTL-UPF isolation rule of the plurality of RTL-UPF isolation rules describes an isolation cell including an AND-gate, a first input of the AND-gate is to be connected to a first terminal of a respective power domain crossing, wherein the first terminal is located in the first power plane domain, a second input of the AND-gate is to be connected to a terminal receiving an isolation cell enable signal, and an output of the AND-gate is to be connected to a second terminal of a respective power domain crossing, wherein the second terminal is located in the second power plane domain.

In Example 6C, the subject matter of Example 5C can optionally include that a clamp value associated with the AND-gate is logic “0”.

In Example 7C, the subject matter of any one of Examples 1C to 6C can optionally include that each RTL-UPF isolation rule from the plurality of RTL-UPF isolation rules includes an associated pre-defined clamp value. The method may further include: determining, if the pre-defined clamp value of a respective RTL-UPF isolation rule is equal to a pre-defined target clamp value; in case that the pre-defined clamp value is not equal to the pre-defined target clamp value, replacing the pre-defined clamp value by the pre-defined target clamp value.

In Example 8C, the subject matter of any one of Examples 1C to 7C can optionally include that each RTL-UPF isolation rule from the plurality of RTL-UPF isolation rules includes an associated pre-defined clamp value. The RTL-UPF isolation rule is selected from only those RTL-UPF isolation rules of the plurality of RTL-UPF isolation rules, in which the associated pre-defined clamp value is equal to a pre-defined target clamp value.

In Example 9C, the subject matter of any one of Examples 1C to 8C can optionally include that the isolation cell requirement is included in a Unified Power Format (UPF) description.

In Example 10C, the subject matter of any one of Examples 5C to 9C can optionally include that the design for test (DFT) description for the RTL-UPF description is determined by adding a scan control logic and associated scan flip flops to the RTL-UPF description, thereby generating at least two power domain crossings between the at least two RTL modules of the plurality of RTL modules. The at least two power domain crossings are unprotected with respect to a floating voltage level on each of the at least two power domain crossing. An isolation cell requirement is determined for each of the at least two power domain crossings. An RTL-UPF isolation rule from the plurality of RTL-UPF isolation rules is selected using the determined isolation cell requirement for each of the at least two power domain crossings. The isolation cells described by the selected RTL-UPF isolation rules are inserted into the DFT structure. The inserted isolation cells share the same isolation cell enable signal.

In Example 11C, the subject matter of any one of Examples 1C to 10C can optionally include that the method further includes manufacturing the circuit in accordance with the DFT structure including the inserted isolation cell.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural”, “plurality” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The phrases “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The phrases “proper subset”, “adjust subset”, and “lesser subset” refer to a subset of a set that is not equal to the set, illustratively, referring to a subset of a set that contains less elements than the set.

The phrase “at least one of” with regard to a group of elements may be used herein to mean at least one element from the group including the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit, and may also be referred to as a “processing circuit,” “processing circuitry,” among others. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality, among others, and conversely that any single processor, controller, or logic circuit detailed herein may be realized as two (or more) separate entities with equivalent functionality, among others.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A system, comprising:
a memory storing instructions which, when executed by a processor, implement a method; and
a processor configured to:
determine a register-transfer level and Unified Power Format (RTL-UPF) description describing a circuit to be manufactured, the circuit comprising a plurality of RTL modules, wherein at least two RTL modules of the plurality of RTL modules are located in different power plane domains,
determine a design for test (DFT) for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing;
determine an isolation cell requirement for the at least one power domain crossing;
select an RTL-UPF isolation rule from a plurality of RTL-UPF isolation rules using the determined isolation cell requirement for the at least one power domain crossing; and
insert an isolation cell described by the selected RTL isolation rule into the DFT.

2. The system of claim 1,
wherein the isolation cell requirement comprises at least one of a driver voltage requirement of a first terminal of a respective power domain crossing, wherein the first terminal is located in a first power plane domain, or a load voltage requirement of a second terminal of the respective power domain crossing, wherein the second terminal is located in a second power plane domain.

3. The system of claim 2,
wherein at least one RTL-UPF isolation rule of the plurality of RTL-UPF isolation rules describes an isolation cell comprising an OR-gate, a first input of the OR-gate is to be connected to a first terminal of a respective power domain crossing, wherein the first terminal is located in the first power plane domain, a second input of the OR-gate is to be connected to a terminal receiving an isolation cell enable signal, and an output of the OR-gate is to be connected to a second terminal of a respective power domain crossing, wherein the second terminal is located in the second power plane domain.

4. The system of claim 3,
wherein a clamp value associated with the OR gate is logic “1”.

5. The system of claim 2,
wherein at least one RTL-UPF isolation rule of the plurality of RTL-UPF isolation rules describes an isolation cell comprising an AND-gate, a first input of the AND-gate is to be connected to a first terminal of a respective power domain crossing, wherein the first terminal is located in the first power plane domain, a second input of the AND-gate is to be connected to a terminal receiving an isolation cell enable signal, and an output of the AND-gate is to be connected to a second terminal of a respective power domain crossing, wherein the second terminal is located in the second power plane domain.

6. The system of claim 5,
wherein a clamp value associated with the AND-gate is logic “0”.

7. The system of claim 1,
wherein each RTL-UPF isolation rule from the plurality of RTL-UPF isolation rules comprises an associated pre-defined clamp value;
the method further comprising:
determining, if the pre-defined clamp value of a respective RTL-UPF isolation rule is equal to a pre-defined target clamp value;
in case that the pre-defined clamp value is not equal to the pre-defined target clamp value, replacing the pre-defined clamp value by the pre-defined target clamp value.

8. The system of claim 1,
wherein each RTL-UPF isolation rule from the plurality of RTL-UPF isolation rules comprises an associated pre-defined clamp value;
wherein the RTL-UPF isolation rule is selected from only those RTL-UPF isolation rules of the plurality of RTL-UPF isolation rules, in which the associated pre-defined clamp value is equal to a pre-defined target clamp value.

9. The system of claim 1,
wherein the isolation cell requirement is included in a Unified Power Format (UPF) description.

10. The system of claim 5,
wherein the design for test (DFT) description for the RTL-UPF description is determined by adding a scan control logic and associated scan flip flops to the RTL-UPF description, thereby generating at least two power domain crossings between the at least two RTL modules of the plurality of RTL modules, wherein the at least two power domain crossings are unprotected with respect to a floating voltage level on each of the at least two power domain crossings;
wherein an isolation cell requirement is determined for each of the at least two power domain crossings;
wherein an RTL-UPF isolation rule from the plurality of RTL-UPF isolation rules is selected using the determined isolation cell requirement for each of the at least two power domain crossings;
wherein the isolation cells described by the selected RTL-UPF isolation rules are inserted into the DFT structure;
wherein the inserted isolation cells share the same isolation cell enable signal.

11. The system of claim 1, further comprising:
one or more devices configured to manufacture the circuit in accordance with the DFT structure comprising the inserted isolation cell.

12. A non-transitory computer readable medium storing instructions which, when executed by a processor, cause the processor to:
determine a register-transfer level and Unified Power Format (RTL-UPF) description describing a circuit to be manufactured, the circuit comprising a plurality of RTL modules, wherein at least two RTL modules of the plurality of RTL modules are located in different power plane domains;
determine a design for test (DFT) description for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing;
determine an isolation cell requirement for the at least one power domain crossing;
select an RTL-UPF isolation rule from a plurality of RTL-UPF isolation rules using the determined isolation cell requirement for the at least one power domain crossing; and
insert an isolation cell described by the selected RTL isolation rule into the DFT description.

13. The non-transitory computer readable medium of claim 12,
wherein the isolation cell requirement comprises at least one of a driver voltage requirement of a first terminal of a respective power domain crossing, wherein the first terminal is located in a first power plane domain, or a load voltage requirement of a second terminal of the respective power domain crossing, wherein the second terminal is located in a second power plane domain.

14. The non-transitory computer readable medium of claim 12,
wherein each RTL-UPF isolation rule from the plurality of RTL-UPF isolation rules comprises an associated pre-defined clamp value;
wherein the instructions are further configured to cause the processor to:
determine, if the pre-defined clamp value of a respective RTL-UPF isolation rule is equal to a pre-defined target clamp value;
in case that the pre-defined clamp value is not equal to the pre-defined target clamp value, replace the pre-defined clamp value by the pre-defined target clamp value.

15. The non-transitory computer readable medium of claim 12,
wherein each RTL-UPF isolation rule from the plurality of RTL-UPF isolation rules comprises an associated pre-defined clamp value;
wherein the RTL-UPF isolation rule is selected from only those RTL-UPF isolation rules of the plurality of RTL-UPF isolation rules, in which the associated pre-defined clamp value is equal to a pre-defined target clamp value.

16. The non-transitory computer readable medium of claim 12,
wherein the isolation cell requirement is included in a Unified Power Format (UPF) description.

17. A method, comprising:
determining a register-transfer level and Unified Power Format (RTL-UPF) description describing a circuit to be manufactured, the circuit comprising a plurality of RTL modules, wherein at least two RTL modules of the plurality of RTL modules are located in different power plane domains,
determining a design for test (DFT) description for the RTL-UPF description by adding a scan control logic and associated scan flip flops to the RTL-UPF description, thereby generating at least one power domain crossing between the at least two power plane domains, wherein the at least one power domain crossing is unprotected with respect to a floating voltage level on the at least one power domain crossing;
determining an isolation cell requirement for the at least one power domain crossing;
selecting an RTL-UPF isolation rule from a plurality of RTL-UPF isolation rules using the determined isolation cell requirement for the at least one power domain crossing; and
inserting an isolation cell described by the selected RTL isolation rule into the DFT description.

18. The method of claim 17,
wherein the isolation cell requirement comprises at least one of a driver voltage requirement of a first terminal of a respective power domain crossing, wherein the first terminal is located in a first power plane domain, or a load voltage requirement of a second terminal of the respective power domain crossing, wherein the second terminal is located in a second power plane domain.

19. The method of claim 17,
wherein each RTL-UPF isolation rule from the plurality of RTL-UPF isolation rules comprises an associated pre-defined clamp value;
the method further comprising:
determining, if the pre-defined clamp value of a respective RTL-UPF isolation rule is equal to a pre-defined target clamp value;
in case that the pre-defined clamp value is not equal to the pre-defined target clamp value, replacing the pre-defined clamp value by the pre-defined target clamp value.

20. The method of claim 17, further comprising:
manufacturing the circuit in accordance with the DFT structure comprising the inserted isolation cell.
